(19) United States
(12) Patent Application Publication
(10) Pub. No.: US 2009/0208786 A1
(43) Pub. Date: Aug. 20, 2009

(54) FUEL CELL SYSTEM

(76) Inventors: Kota Manabe, Aichi (JP); Masahiro Shige, Osaka (JP); Yasuhiro Nonobe, Aichi (JP)

Correspondence Address: KENYON & KENYON LLP, 1500 K STREET N.W., SUITE 700, WASHINGTON, DC, 20005, US

(21) Appl. No.: 12/300,061

(22) PCT Filed: Apr. 19, 2007
(86) PCT No.: PCT/JP2007/058994

§ 371 Date: Nov. 7, 2008

(30) Foreign Application Priority Data
May 9, 2006 (JP) 2006-130487

(51) Int. Cl. H01M 8/04; H01M 8/00

(52) U.S. Cl. 429/17; 429/24; 429/12; 429/23

(57) ABSTRACT

There is provided a fuel cell system capable of notifying a user that control for low-temperature countermeasure is performed, without any strange feeling and false recognition. When control for low-temperature countermeasure such as scavenging at system termination or warm-up at system start-up is made, the user is reliably notified that the control is performed, by a text message or a speech message. Consequently, even in a situation where the system is operating after an ignition key is turned off, the user suffers neither strange feeling nor false recognition.

### TECHNICAL FIELD

The present invention relates to a fuel cell system.

### BACKGROUND ART

When an outside temperature is low, there is a problem that water generated in a fuel cell system after the termination of the system freezes to break pipes, valves and the like. Moreover, a fuel cell usually has poor starting properties as compared with another power source, and there has also been a problem that a desired voltage/current cannot be supplied at a low temperature and an apparatus cannot be started.

In view of such problems, there are suggested a method for performing scavenging at the termination of the fuel cell system to discharge a water content accumulated in the fuel cell to the outside (e.g., see Patent Document 1) and a method for performing warm-up at the start-up of the fuel cell system to increase the power generation efficiency of the fuel cell (e.g., see Patent Document 2).

[Patent Document 1] Japanese Patent Application Laid-Open No. 2005-141943

[Patent Document 2] Published Japanese translations of PCT international publication No. 2003-504807

### DISCLOSURE OF THE INVENTION

However, scavenging or warm-up (control for low-temperature countermeasure) to be performed at the termination or start-up of a fuel cell system is different from processing to be performed during a usual operation. Therefore, when the control for low-temperature countermeasure is suddenly performed, a user has strange feeling. Moreover, the user who is not notified that such control for low-temperature countermeasure is performed might falsely recognize failure, even when the control for low-temperature countermeasure is performed.

The present invention has been developed in view of the above-mentioned situation, and an object thereof is to provide a fuel cell system capable of notifying a user that control for low-temperature countermeasure is performed, without any strange feeling and false recognition.

To solve the above problem, the fuel cell system according to the present invention is characterized by comprising: control means for performing control for low-temperature countermeasure; and notifying means for notifying that the control for low-temperature countermeasure is performed.

According to such a constitution, when the control for low-temperature countermeasure (scavenging at system termination or the like) is performed, a user can reliably be notified that the control is performed, by a text message, a speech message or the like, and the user suffers neither strange feeling nor false recognition.

Here, in the above constitution, a configuration is preferable in which the control means performs at least one of warm-up at system start-up and scavenging at system termination as the control for low-temperature countermeasure, and the notifying means notifies that the control is performed, by use of at least one somesthetic medium selected from the group consisting of light, sound, image, heat, vibration, wind and odor.

Moreover, in the above constitution, it is preferable that the control means performs the warm-up at the system start-up and the scavenging at the system termination and that the notifying means changes a notifying configuration between the system start-up and the system termination. Furthermore, the notifying means preferably notifies time concerning the control for low-temperature countermeasure. In addition, the notifying means preferably includes a display device which displays an image or a character indicating that the control for low-temperature countermeasure is performed.

Furthermore, in the above constitution, a configuration is preferable in which the control means performs the scavenging as the control for low-temperature countermeasure, and further includes estimating means for estimating time required for the scavenging from the amount of a water content of a fuel cell needed to be decreased and the state amount of the fuel cell. In this case, a configuration is more preferable in which the estimating means includes first calculation means for obtaining the amount of the water content needed to be decreased, from the residual water amount of the fuel cell at the time and a set target residual water amount; second calculation means for obtaining the amount of the water content of the fuel cell to be decreased per unit time based on the state amount of the fuel cell; and third calculation means for obtaining time required for the scavenging from the amount of the water content of the fuel cell needed to be decreased and the amount of the water content of the fuel cell to be decreased per unit time. Furthermore, a configuration is preferable in which the state amount of the fuel cell includes an output current, an output voltage, an air stoichiometric ratio, an exhaust oxidizing gas temperature and an exhaust oxidizing gas amount.

Moreover, a required scavenging time estimating method according to the present invention is a method for estimating time required for the scavenging of a fuel cell system, characterized by comprising: a first step of obtaining the amount of a water content of a fuel cell needed to be decreased, from the residual water amount of the fuel cell at the time and a set target residual water amount; a second step of obtaining the amount of the water content of the fuel cell to be decreased per unit time based on the state amount of the fuel cell; and a third step of obtaining time required for the scavenging from the amount of the water content of the fuel cell needed to be decreased and the amount of the water content of the fuel cell to be decreased per unit time.

As described above, according to the present invention, a user can be notified that control for low-temperature countermeasure is performed, without any strange feeling and false recognition.

### BRIEF DESCRIPTION OF THE DRAWINGS

FIG. 1 is a diagram showing a constitution of a fuel cell system according to a first embodiment;

FIG. 2 is a diagram for explaining a constitution around a humidifier according to the embodiment;

FIG. 3 is a block diagram showing a functional constitution of a control unit according to the embodiment;

FIG. 4 is a graph showing a relation between an impedance and a residual water amount according to the embodiment;

FIG. 5 is a diagram illustrating a display screen according to the embodiment;

FIG. 6 is a diagram illustrating the display screen according to the embodiment;

FIG. 7 is a flow chart showing system termination according to the embodiment;

FIG. 8 is a flow chart showing the calculation of the amount of a stack water content to be decreased according to the embodiment;

FIG. 9 is a flow chart showing system start-up according to a second embodiment;

FIG. 10 is a diagram illustrating a display screen according to the embodiment;

FIG. 11 is a diagram illustrating the display screen according to the embodiment;

FIG. 12A is a diagram illustrating a display screen according to a modification; and

FIG. 12B is a diagram illustrating a display screen according to the modification.

### BEST MODE FOR CARRYING OUT THE INVENTION

Embodiments according to the present invention will hereinafter be described with reference to the drawings.

### A. First Embodiment

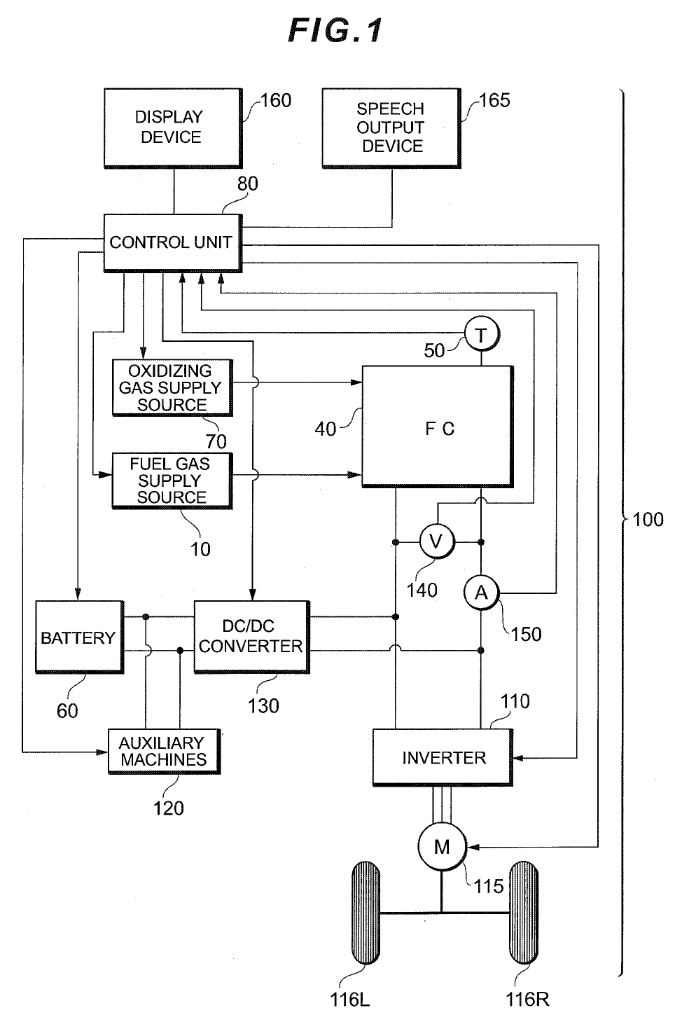

FIG. 1 is a diagram showing a main part constitution of a fuel cell system 100. In the present embodiment, the fuel cell system to be mounted on a vehicle such as a fuel cell hybrid vehicle (FCHV), an electric car or a hybrid car is assumed, but the system is applicable to not only the vehicle but also any type of mobile body (e.g., a ship, an airplane, a robot or the like) and a stational power source.

A fuel cell 40 is means for generating a power from a reactant gas (a fuel gas and an oxidizing gas) to be supplied, and any type of fuel cell such as a solid polymer type, a phosphoric type or a melting carbonate type may be used. The fuel cell 40 has a stack structure in which a plurality of unitary cells including an MEA and the like are laminated in series. An output voltage (hereinafter referred to as the FC voltage) and an output current (hereinafter referred to as the FC current) of this fuel cell 40 are detected by a voltage sensor 140 and a current sensor 150, respectively. A fuel gas such as a hydrogen gas is supplied from a fuel gas supply source 10 to a fuel pole (the anode) of the fuel cell 40, whereas an oxidizing gas such as air is supplied from an oxidizing gas supply source 70 to an oxygen pole (the cathode).

The fuel gas supply source 10 is constituted of, for example, a hydrogen tank, various valves and the like, and adjusts a valve open degree, ON/OFF time and the like to control the amount of the fuel gas to be supplied to the fuel cell 40.

The oxidizing gas supply source 70 is constituted of, for example, an air compressor, a motor for driving the air compressor, an inverter and the like, and adjusts the rotation number or the like of the motor to adjust the amount of the oxidizing gas to be supplied to the fuel cell 40.

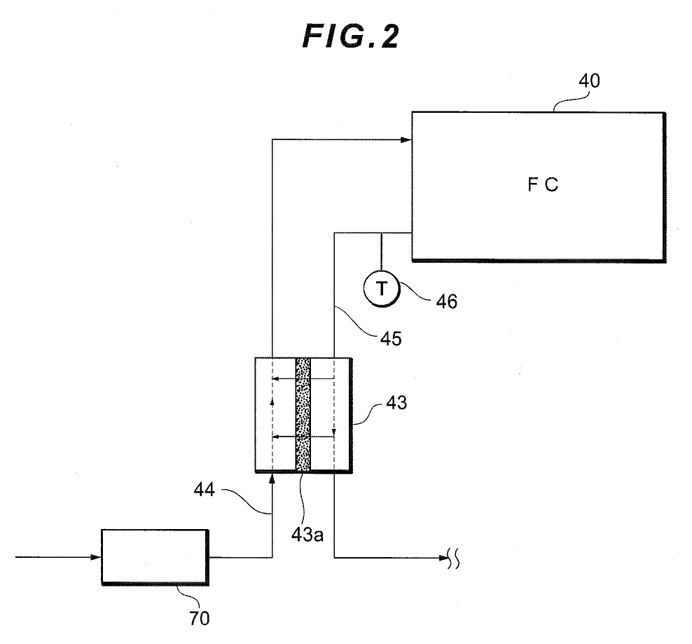

FIG. 2 is a diagram for explaining a humidifier 43 provided between the oxidizing gas supply source 70 and the fuel cell 40.

The humidifier 43 is a humidifier which performs water content exchange and heat exchange between an oxidizing off gas discharged from the fuel cell 40 and a supply oxidizing gas to be supplied to the fuel cell 40 via a vapor exchange film 43. The supply oxidizing gas is supplied from the oxidizing gas supply source 70 to the fuel cell 40 via a supply gas passage 44, the humidifier 43 and the like. On the other hand, the oxidizing off gas discharged from the fuel cell 40 is discharged from the fuel cell system via an exhaust gas passage 45, the humidifier 43 and the like. This exhaust gas passage 45 is provided with a temperature sensor 46 which measures the temperature of the oxidizing off gas.

Turning back to FIG. 1, a battery 60 is a chargeable/dischargeable secondary cell, and is constituted of, for example, a nickel hydrogen battery or the like. Needless to say, instead of the battery 60, a chargeable/dischargeable accumulator (e.g., a capacitor) other than the secondary cell may be provided. This battery 60 is connected in parallel with the fuel cell 40 via a DC/DC converter 130.

An inverter 110 is a PWM inverter of, for example, a pulse width modulation system, and converts a direct-current power output from the fuel cell 40 or the battery 60 into a three-phase alternating-current power in accordance with a control command given from a control unit 80 to supply the power to a traction motor 115. The traction motor 115 is a motor (i.e., a power source of the mobile body) for driving wheels 116L, 116R, and the rotation number of such a motor is controlled by the inverter 110. This traction motor 115 and the inverter 110 are connected to a fuel cell 40 side.

The DC/DC converter 130 is a full bridge converter constituted of, for example, four power transistors and a driving circuit for exclusive use (they are not shown). The DC/DC converter 130 has a function of raising or lowering a DC voltage input from the battery 60 to output the voltage to the fuel cell 40 side, and a function of raising or lowering the DC voltage input from the fuel cell 40 or the like to output the voltage to a battery 60 side. Moreover, the charging/discharging of the battery 60 is realized by the function of the DC/DC converter 130.

Auxiliary machines 120 such as a vehicle auxiliary machine and an FC auxiliary machine are connected between the battery 60 and the DC/DC converter 130. The battery 60 is a power source of these auxiliary machines 120. It is to be noted that the vehicle auxiliary machine is any type of power device (an illumination device, an air conditioner, a hydraulic pump or the like) for use in the operation of the vehicle, and the FC auxiliary machine is any type of power device (a pump for supplying the fuel gas or the oxidizing gas or the like) for use in the operation of the fuel cell 40.

The control unit (the control means) 80 is constituted of a CPU, an ROM, an RAM and the like, and centrally controls respective system sections based on sensor signals input from the voltage sensor 140, the current sensor 150, a temperature sensor 50 which detects the temperature of the fuel cell 40, an SOC sensor which detects the charged state of the battery 60, an accelerator pedal sensor which detects the open degree of an accelerator pedal and the like. Moreover, the control unit 80 according to the present embodiment performs scavenging (control for low-temperature countermeasure) to be executed at system termination.

A display device (notifying means) 160 is constituted of a liquid crystal display device, any type of lamp and the like, and a speech output device (notifying means) 170 is constituted of a speaker, an amplifier, a filter and the like. The control unit 80 notifies various control contents by use of the display device 160 and the speech output device. The control contents include the control contents of the scavenging to be executed at the system termination (e.g., the display of the termination message of the scavenging, the calculation of time required for the termination of the scavenging and the like; details will be described later).

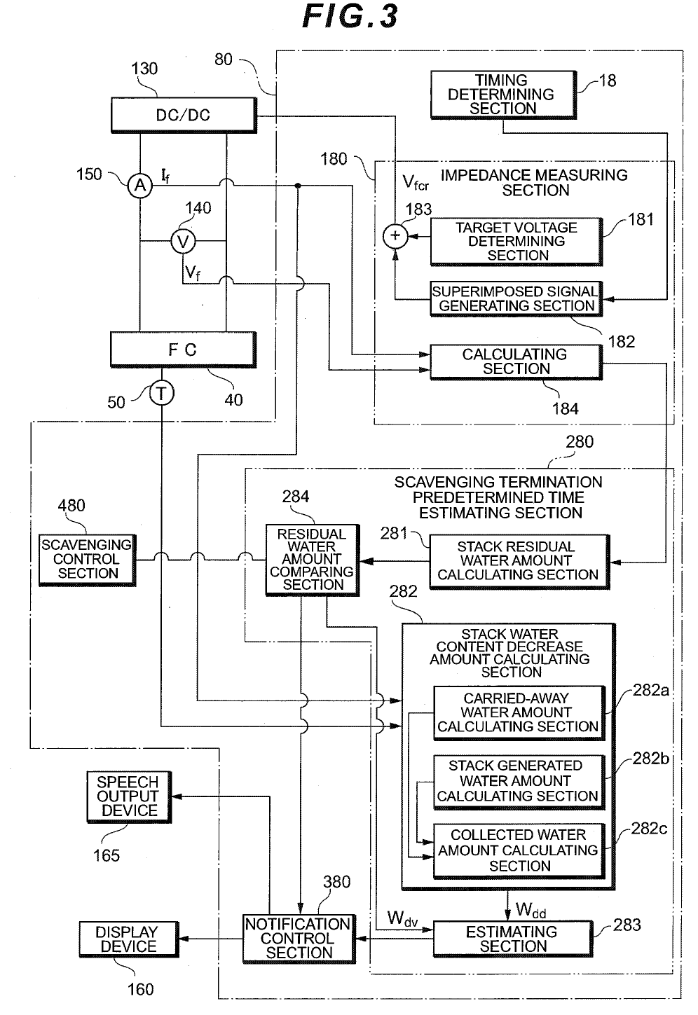

FIG. 3 is a block diagram for explaining the scavenging according to the present embodiment.

The control unit 80 realizes the functions of a timing determining section 18, an impedance measuring section 180, a scavenging termination predetermined time estimating section 280, a notification control section 380 and a scavenging control section 480.

<Timing Determining Section 18>

The timing determining section 18 determines a timing to start impedance measurement. On detecting that an ignition key is turned off, the timing determining section 18 judges that the impedance measurement necessary for the scavenging should be started, to send a start command for the impedance measurement to a superimposed signal generating section 182. It is to be noted that in the present embodiment, the start command for the impedance measurement is sent at a time when the ignition key is turned off, but the start command for the impedance measurement may be sent at any arbitrary timing.

<Impedance Measuring Section 180>

The impedance measuring section 180 includes a target voltage determining section 181, the superimposed signal generating section 182, a voltage instruction signal generating section 183 and a calculating section 184.

The target voltage determining section 181 determines an output target voltage (e.g., 300 V or the like) based on the sensor signals input from the accelerator pedal sensor, the SOC sensor and the like to output this voltage to the voltage instruction signal generating section 183.

The superimposed signal generating section 182 generates a signal (e.g., a sine wave of a specific frequency with an amplitude value of 2 V or the like) for the impedance measurement to be superimposed on the output target voltage in accordance with the start command for the impedance measurement sent from the timing determining section 18, to output this signal to the voltage instruction signal generating section 183. It is to be noted that the parameters (the type of a waveform, a frequency, an amplitude value) of the signal for the impedance measurement may appropriately be set in accordance with system design or the like.

The voltage instruction signal generating section 183 superimposes the signal for the impedance measurement to the output target voltage to output a voltage instruction signal Vfcr to the DC/DC converter 130. The DC/DC converter 130 performs the voltage control of the fuel cell 40 or the like based on the given voltage instruction signal Vfcr.

The calculating section 184 samples a voltage (the FC voltage) Vf of the fuel cell 40 detected by the voltage sensor 140 and a current (the FC current) If detected by the current sensor 150 at a predetermined sampling rate, to perform Fourier transform (FFT calculation or DFT calculation) and the like. The calculating section 184 divides the FC voltage signal subjected to the Fourier transform by the FC current signal subjected to the Fourier transform to obtain the impedance of the fuel cell 40. The calculating section 184 outputs the thus obtained impedance (hereinafter referred to as the stack impedance) of the fuel cell 40 to a stack residual water amount calculating section 281.

<Scavenging Termination Predetermined Time Estimating Section 280>

The scavenging termination predetermined time estimating section (estimating means) 280 includes the stack residual water amount calculating section 281, a stack water content decrease amount calculating section 282, an estimating section 283 and a residual water amount comparing section 284.

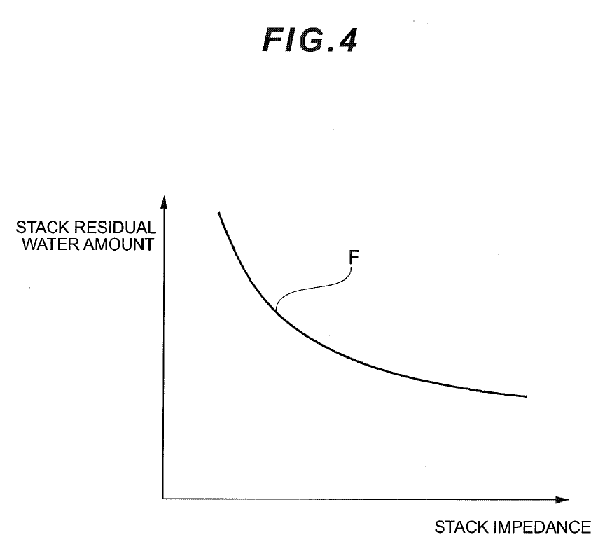

The stack residual water amount calculating section 281 calculates the amount of residual water in a stack (the stack residual water amount) based on the stack impedance supplied from the calculating section 184. In the stack residual water amount calculating section 281, a function F indicating a relation between the stack impedance and the stack residual water amount as shown in FIG. 4 is beforehand stored. The stack residual water amount calculating section 281 substitutes the stack impedance into this function F to obtain the stack residual water amount. The stack residual water amount calculating section 281 outputs the thus obtained stack residual water amount to the residual water amount comparing section 284.

The residual water amount comparing section 284 compares a stack residual water amount Ws supplied from the stack residual water amount calculating section 281 with a preset target residual water amount Wo to judge whether or not the scavenging is necessary. In a case where the stack residual water amount Ws is the target residual water amount Wo or less, the residual water amount comparing section 284 judges that the scavenging is unnecessary, and sends the terminating instruction of the scavenging to the notification control section 380.

On the other hand, in a case where the stack residual water amount Ws exceeds the target residual water amount Wo, the residual water amount comparing section (first calculation means) 284 judges that the scavenging is necessary, and the section subtracts the target residual water amount Wo from the stack residual water amount Ws to obtain a water content amount Wd to be decreased (hereinafter referred to as the amount of the water content needed to be decreased), and sends this amount to the estimating section 283.

The stack water content decrease amount calculating section (second calculation means) 282 calculates an amount Wdd of the stack water content to be decreased per unit time, and includes a carried-away water amount calculating section 282a, a stack generated water amount calculating section 282b and a collected water amount calculating section 282c. It is to be noted that the specific calculation method or the like of the amount Wdd of the stack water content to be decreased per unit time will be clarified in detail in the paragraphs for explaining the operation of the embodiment.

The estimating section (third calculation means) 283 estimates time (hereinafter referred to as required scavenging time) required for the scavenging by use of the amount Wd of the water content needed to be decreased supplied from the residual water amount comparing section 284 and the amount Wdd of the stack water content to be decreased per unit time supplied from the stack water content decrease amount calculating section 282, to output the same to the notification control section 380.

<Notification Control Section 380>

The notification control section 380 controls output contents from the display device 160 and the speech output device 165 based on notification from the residual water amount comparing section 284 or the required scavenging time output from the estimating section 283.

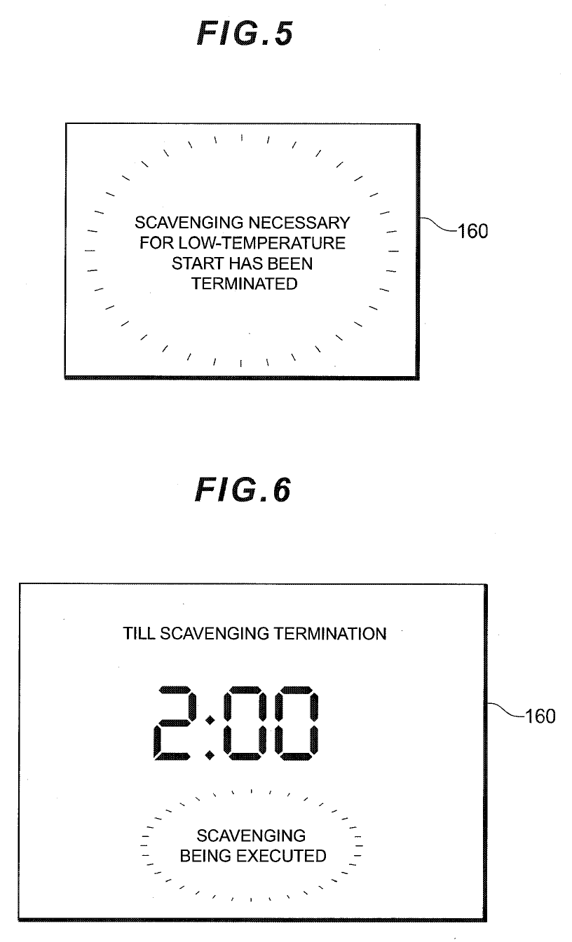

Specifically, in a case where the terminating instruction of the scavenging is notified from the residual water amount comparing section 284, for example, a scavenging termination message is displayed in the display device 160 (see FIG. 5), and a speech message or an alarm sound indicating the termination of the scavenging is output from the speech output device 165.

On the other hand, when the estimating section 283 outputs the required scavenging time, for example, a message indicating the required scavenging time (estimated time till the scavenging termination) estimated by the estimating section 283 is displayed in the display device 160 (see FIG. 6), and a speech message indicating the estimated time is output from the speech output device 165. An operation at the termination of the present system will be described.

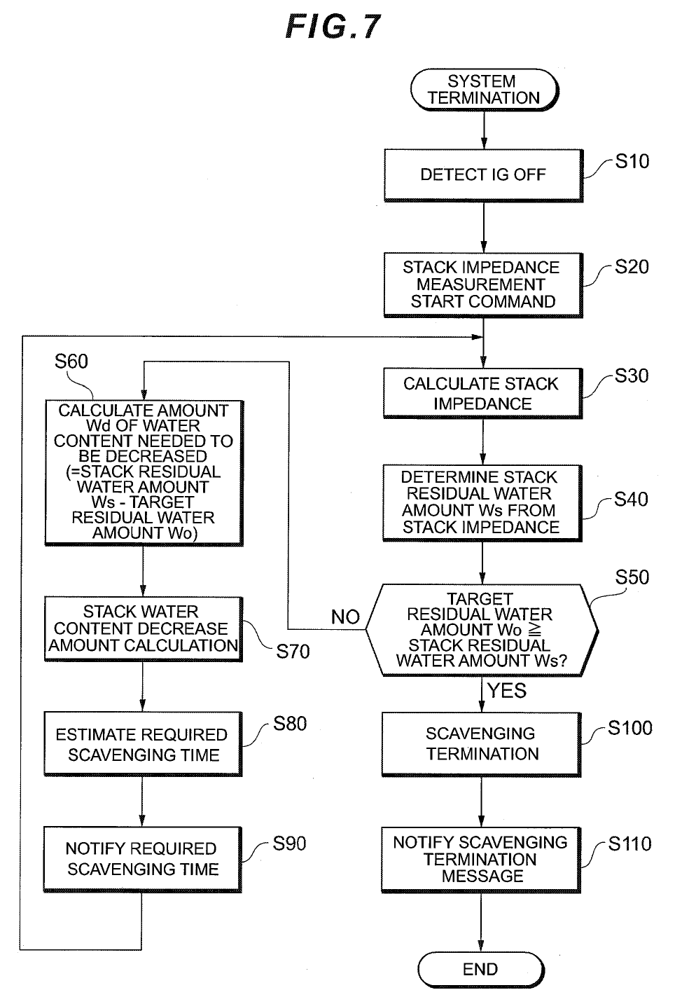

FIG. 7 is a flow chart showing the system termination according to the present embodiment.

On detecting that the ignition key is turned off, the timing determining section 18 of the control unit 80 sends the start command of the stack impedance measurement necessary for the scavenging to the superimposed signal generating section 182 (step S10→step S20).

On receiving the measurement start command, the superimposed signal generating section 182 of the impedance measuring section 180 generates the signal for the impedance measurement to be superimposed on the output target voltage to output this signal to the voltage instruction signal generating section 183.

The voltage instruction signal generating section 183 superimposes the signal for the impedance measurement output from the superimposed signal generating section 182 on the output target voltage supplied from the target voltage determining section 181, to output the voltage instruction signal Vfcr to the DC/DC converter 130. The DC/DC converter 130 perform the voltage control of the fuel cell 40 or the like based on the given voltage instruction signal Vfcr. The calculating section 184 samples the FC voltage Vf detected by the voltage sensor 140 and the FC current If detected by the current sensor 150 at the predetermined sampling rate, then performs the Fourier transform, and divides the FC voltage signal subjected to the Fourier transform by the FC current signal subjected to the Fourier transform or the like to obtain the impedance (i.e., the stack impedance) of the fuel cell 40 (step S30). The calculating section 184 outputs the thus obtained stack impedance to the stack residual water amount calculating section 381.

The stack residual water amount calculating section 281 of the scavenging termination predetermined time estimating section 280 estimates the stack residual water amount from the received stack impedance. Specifically, the stack residual water amount calculating section 281 substitutes the received stack impedance into the function F shown in FIG. 4 to obtain the stack residual water amount Ws (step S40). The stack residual water amount calculating section 281 outputs the thus obtained stack residual water amount Ws to the residual water amount comparing section 284.

The residual water amount comparing section 284 compares the stack residual water amount Ws supplied from the stack residual water amount calculating section 281 with the preset target residual water amount Wo to judge whether or not to start (or continue) the scavenging (step S50). This target residual water amount Wo can be obtained by, for example, an experiment or the like.

Here, when the stack residual water amount Ws exceeds the target residual water amount Wo (the step S50; NO), the residual water amount comparing section 284 obtains the amount Wd of the water content needed to be decreased (=the stack residual water amount Ws—the target residual water amount Wo) (step S60) to send this amount to the estimating section 283. Furthermore, the residual water amount comparing section 284 sends the start (or continuation) instruction of the scavenging to the scavenging control section 480, and sends the calculating instruction of the amount Wdd of the stack water content to be decreased per unit time to the stack water content decrease amount calculating section 282.

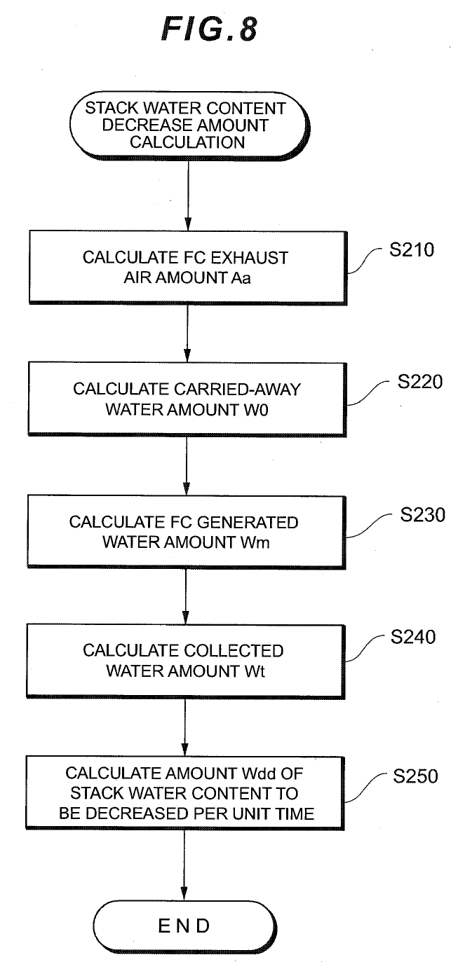

On receiving such an instruction, the stack water content decrease amount calculating section 282 executes stack water content decrease amount calculation shown in FIG. 8 (step S70). First, the carried-away water amount calculating section 282a substitutes an air stoichiometric ratio Sa and the FC current If into the following equation (1) to calculate an FC exhaust air amount Aa.

Aa[mol/sec]=If*(400/(F*4))*(100/21)*Sa−If*400/(F*4) (1),

in which F is Faraday constant.

Next, the carried-away water amount calculating section 282a calculates a saturated vapor partial pressure Pt by use of an FC exhaust air temperature detected by the temperature sensor 46 (see FIG. 2), and substitutes the saturated vapor partial pressure Pt and the FC exhaust air amount Aa into the following equation (2) to calculate a carried-away water amount Wc. The carried-away water amount calculating section 282a outputs the calculated carried-away water amount Wc to the collected water amount calculating section 282c.

Wc[g/sec]=Aa*Pt/((Pt+100)*18) (2)

On the other hand, the stack generated water amount calculating section 282b substitutes the FC current If into the following equation (3) to calculate an FC generated water amount Wm, and outputs the same to the collected water amount calculating section 282c.

Wm[g/sec]=If*400/(2*F)*18 (3)

The collected water amount calculating section 282c obtains a vapor exchange ratio Cr of the humidifier 43 based on the FC exhaust air amount Aa (see the equation (1)) calculated by the carried-away water amount calculating section 282a or the like. The collected water amount calculating section 282c substitutes the obtained vapor exchange ratio Cr and the supplied FC generated water amount Wm into the following equation (4) to calculate a collected water amount Wt.

Wt[g/sec]=Wm*Cr (4)

When the collected water amount calculating section 282c calculates the collected water amount Wt, the stack water content decrease amount calculating section 282 substitutes the FC generated water amount Wm, the collected water amount Wt and the carried-away water amount Wc into the following equation (5) to derive the amount Wdd of the stack water content to be decreased per unit time, and outputs the same to the estimating section 283, thereby ending the processing.

Wdd[g/sec]=Wm+Wt−Wc (5)

The estimating section 283 substitutes the amount Wdd of the stack water content to be decreased per unit time supplied from the stack water content decrease amount calculating section 282 and the amount Wd of the water content needed to be decreased supplied from the residual water amount comparing section 284 into the following equation (6) to calculate an estimated required scavenging time Tf (step S80), and the section sends the same to the notification control section 380.

Tf[sec]=Wd/Wdd (6)

On receiving the estimated required scavenging time Tf from the estimating section 283, the notification control section 380 displays a message indicating the estimated required scavenging time as shown in FIG. 6 in the display device 160, outputs a speech message indicating the predetermined time from the speech output device 165 (step S90), and returns to the step S30. Here, while the stack residual water amount Ws exceeds the target residual water amount Wo (the step S40; YES), the above processing is repeatedly executed.

Afterward, on detecting that the stack residual water amount Ws is the target residual water amount Wo or less (the step S40; YES), the residual water amount comparing section 284 sends the terminating instruction of the scavenging to the notification control section 380 and the scavenging control section 480. The scavenging control section 480 performs control (the supply stop of the oxidizing gas or the like) to terminate the scavenging based on such an instruction (step S100). The notification control section 380 displays the scavenging termination message in the display device 160 as shown in FIG. 5, and outputs the speech message indicating the termination of the scavenging or the like from the speech output device 165 (step S110), thereby ending the system termination.

As described above, according to the present embodiment, when the scavenging (i.e., the control for low-temperature countermeasure) is performed at the system termination, a user is reliably notified that the processing is performed, by a text message or the speech message. Therefore, even in a situation where the system is operating after the ignition key is turned off, the user suffers neither strange feeling nor false recognition.

### B. Second Embodiment

In the above first embodiment, a case where control for low-temperature countermeasure is performed at system termination has been described, but control for low-temperature countermeasure such as warm-up is sometimes necessary, for example, at system start-up. An embodiment for realizing such control will hereinafter be described. It is to be noted that a hardware constitution of a fuel cell system according to a second embodiment is similar to that of the above first embodiment, and hence drawing and detailed description are omitted.

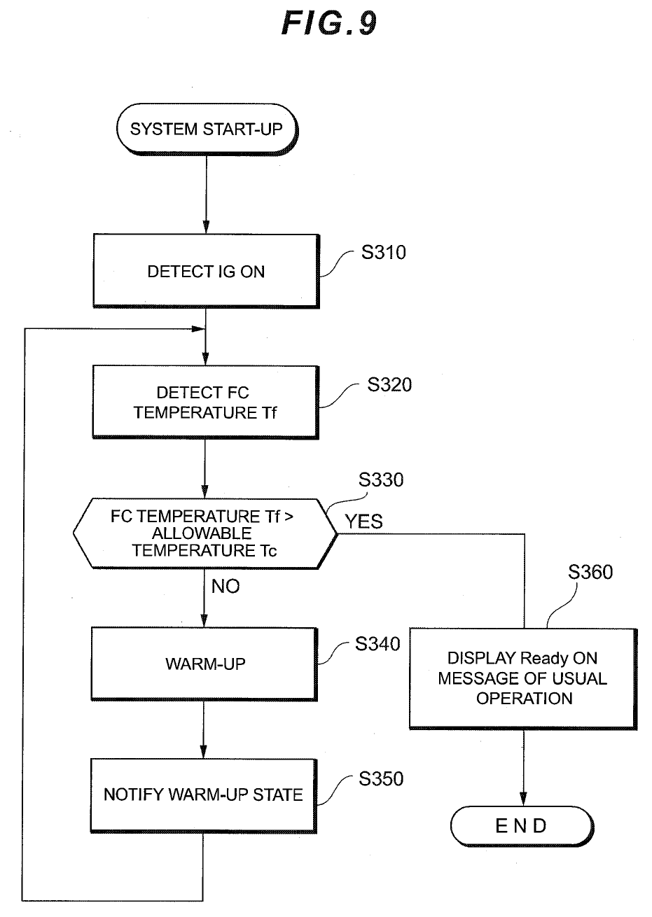

FIG. 9 is a flow chart showing start-up according to the present embodiment.

On detecting that an ignition key is turned on, a control unit 80 grasps an FC temperature Tf at the time from a temperature sensor 50 (step S310→step S320) Then, the control unit 80 compares a preset allowable temperature Tc (a temperature for judging whether or not to allow start by a usual operation) with the FC temperature Tf (step S330).

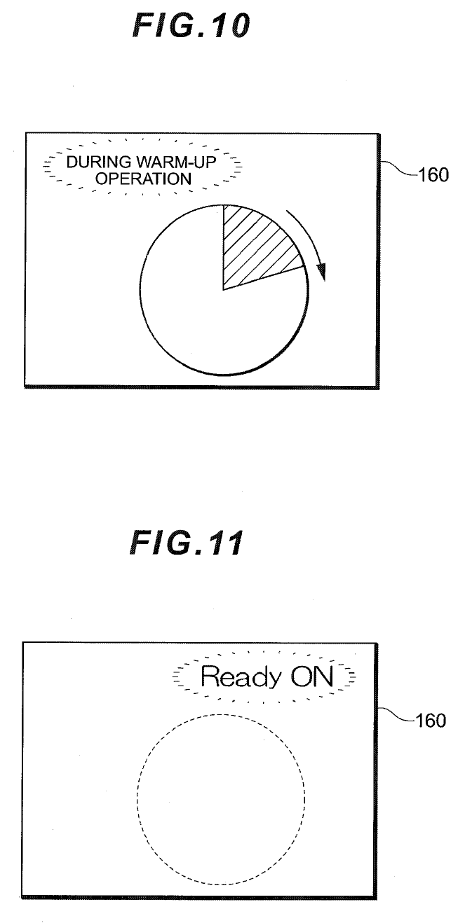

When the FC temperature Tf is the allowable temperature Tc or less (step S330; NO), the control unit 80 starts warm-up (e.g., power generation is performed in a highly loaded state to allow a fuel cell to generate heat or the like) (step S340). Furthermore, the control unit 80 displays a graph indicating a warm-up state or the like in a display device 160 as shown in FIG. 10, and outputs a speech message indicating the warm-up state from a speech output device 165 (step S350). The graph shown in FIG. 10 will be described in detail. The control unit 80 sets, for example, the present FC temperature Tf to 0%, and sets the allowable temperature Tc to 100% to form the graph. Afterward, the warm-up is started. When the FC temperature rises, the control unit 80 performs display control to enlarge a region (a hatched part of FIG. 10) indicating the FC temperature in accordance with the rise of the FC temperature. It is to be noted that such a display configuration is merely one example, and any arbitrary display configuration may be employed (described later).

When the control unit 80 performs such display, the unit returns to the step S320 to execute the above series of processing. While such processing is executed, it is detected that the FC temperature Tf exceeds the allowable temperature Tc (the step S330; YES). Then, the control unit 80 displays, in the display device 160, a Ready ON message indicating that the usual operation can be performed as shown in FIG. 11, and outputs the Ready ON message from the speech output device 165 (step S360), thereby ending the processing.

As described above, according to the present embodiment, when the warm-up (i.e., control for low-temperature countermeasure) is performed at the system start-up, a user is reliably notified that the processing is performed, by a text message or a speech message. Therefore, even in a situation where the system is operating after the ignition key is turned on and before the usual operation is started, the user suffers neither strange feeling nor false recognition.

<Modifications>

(Modification 1)

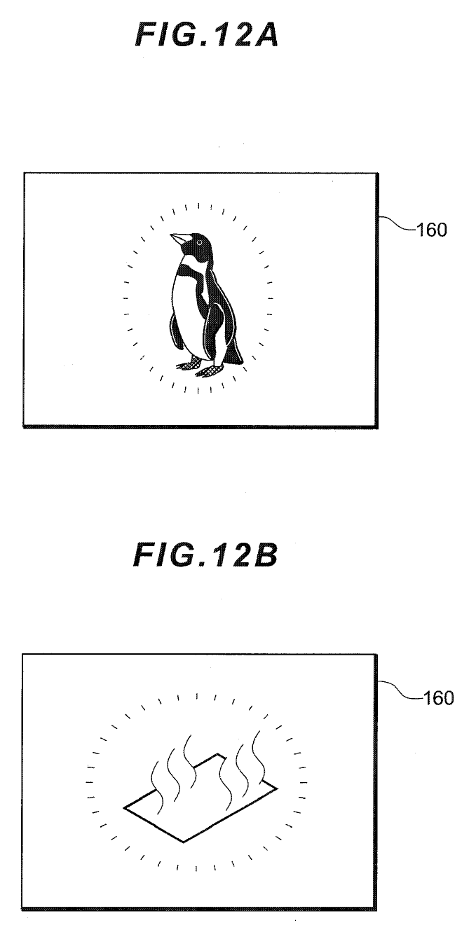

In the second embodiment, the change of an FC temperature is displayed, but predetermined time until an allowable temperature Tc is reached (time concerning control for low-temperature countermeasure; hereinafter referred to as the predetermined Ready ON time) may be obtained from the change of an FC temperature Tf to output the same from a display device 160 or a speech output device 165. Here, to display the predetermined Ready ON time, the number of seconds till the start of a usual operation may digitally be displayed, or time elapsed with respect to the predetermined Ready ON time may be displayed in a bar graph. Here, the predetermined Ready ON time may successively be corrected while performing the calculation in real time. However, if strict precision is not demanded (e.g., a case where the image of the predetermined Ready ON time is displayed in the bar graph or the like), the time does not have to be corrected. Moreover, the predetermined Ready ON time does not necessarily have to be notified. Instead of (or in addition to) the display of the predetermined Ready ON time, while warm-up (the control for low-temperature countermeasure) is performed, an image (e.g., an image indicating a penguin; refer to FIG. 12A) indicating that the warm-up is being operated or an alarm mark (see FIG. 12B) may be displayed in the display device 160.

(Modification 2)

Moreover, in the second embodiment, the warm-up state is notified based on the FC temperature Tf. However, when the thermal capacity of a fuel cell system 100 is known, the warm-up state may be notified based on the amount of heat to be generated. This respect will be described in detail. First, a control unit 80 substitutes the FC temperature Tf and an allowable temperature Tc into the following equation (7) to calculate the necessary amount Qn of the heat to be generated.

Qn=(Tc−Tf)*C (7),

in which C is the thermal capacity of the system.

Next, the control unit 80 substitutes an FC voltage Vf and an FC current If into the following equation (8) to calculate an integral value Di of the amount of the heat generated by the system.

Di=∫{(OCV−Vⱼ)×I_{f}}dₜ[J] (8),

in which OCV is an open circuit voltage (nearly equal to 492 V).

The control unit 80 sets the present integral value Di of the amount of the heat generated by the system to 0%, and sets the necessary amount Qn of the heat to be generated to 100% to form a graph. Afterward, when the warm-up is started, a region indicating the integral value Di of the amount of the heat generated by the system enlarges with the elapse of time. When the integral value Di of the amount of the heat generated by the system reaches the necessary amount Qn of the heat to be generated, a Ready ON message indicating that usual start-up can be performed is output from a display device 160 and a speech output device 165. Thus, the warm-up state may be notified based on the amount of the heat to be generated.

C. Others

Needless to say, the above modifications according to the second embodiment may be applied to the above first embodiment. Moreover, a constitution according to the first embodiment is combined with a constitution according to the second embodiment, and scavenging at system termination and warm-up at system start-up may be used together. In this case, a notifying configuration indicating the proceeding situation of the scavenging and a notifying configuration indicating the proceeding situation of the warm-up may be changed. Specifically, the type or color of an image to be displayed, the type or size of a text, a lighting pattern or the like may be changed, or the type (male, female or the like) of voice to be output, the type of an alarm sound or the like may be changed.

Moreover, in the above embodiments, the display device 160 and speech output device 165 for the notification by a somesthetic medium such as the image or the sound have been illustrated, but notifying means for the notification using at least one somesthetic medium selected from the group consisting of light, sound, image, heat, vibration, wind and odor may be used.

1. A fuel cell system comprising:
control means for performing warm-up at system start-up, and performing scavenging at system termination as control for low-temperature countermeasure; and
a notifying device for notifying that the warm-up and the scavenging are performed.

2. The fuel cell system according to claim 1, wherein the control device performs the scavenging instead of the warm-up at the system start-up.

3. The fuel cell system according to claim 1, wherein the notifying device notifies that the control is performed, by use of at least one somesthetic medium selected from the group consisting of light, sound, image, heat, vibration, wind and odor.

4. The fuel cell system according to claim 1, wherein the control device changes a notifying configuration between the warm-up and the scavenging.

5. The fuel cell system comprising:
a notifying device for notifying time concerning the performing of the warm-up and time concerning the performing of the scavenging.

6. The fuel cell system according to claim 1, wherein the notifying device includes a display device which displays an image or a character indicating that the the warm-up and the scavenging are performed.

7. A fuel cell system comprising:
a control device to perform control for low-temperature countermeasure; and
a notifying device to notify that the control for lower-temperature countermeasure is performed,
wherein the control device performs the scavenging as the control for low-temperature countermeasure, and further includes an estimating device to estimate the time required for the scavenging from the amount of a water content of a fuel cell needed to be decreased and the state amount of the fuel cell.

8. The fuel cell system according to claim 7, wherein the estimating device includes:
a first calculation device to obtain the amount of the water content needed to be decreased, from the residual water amount of the fuel cell at the time and a set target residual water amount;
a second calculation device to obtain the amount of the water content of the fuel cell to be decreased per unit time based on the state amount of the fuel cell; and
a third calculation device to obtain the time required for the scavenging from the amount of the water content of the fuel cell needed to be decreased and the amount of the water content of the fuel cell to be decreased per unit time.

9. The fuel cell system according to claim 8, wherein the state amount of the fuel cell includes an output current, an output voltage, an air stoichiometric ratio, an exhaust oxidizing gas temperature and an exhaust oxidizing gas amount.

10. A required scavenging time estimating method for estimating time required for the scavenging of a fuel cell system, comprising:
a first step of obtaining the amount of a water content of a fuel cell needed to be decreased, from the residual water amount of the fuel cell at the time and a set target residual water amount;
a second step of obtaining the amount of the water content of the fuel cell to be decreased per unit time based on the state amount of the fuel cell; and
a third step of obtaining time required for the scavenging from the amount of the water content of the fuel cell needed to be decreased and the amount of the water content of the fuel cell to be decreased per unit time.

11. A mobile body on which a fuel cell system is mounted, comprising:
a control device to perform warm-up at system start-up, and to perform scavenging at system termination as control for low-temperature countermeasure; and
a notifying device to notify that the warm-up and the scavenging are performed.
